(19) United States
(12) Patent Application Publication
(10) Pub. No.: US 2007/0260750 A1
(43) Pub. Date: Nov. 8, 2007

(54) ADAPTABLE DATA CONNECTOR

(75) Inventors: Craig Frederick Feied, Washington, DC (US); Fidrik Iskandar, Fairfax, VA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/683,831

(22) Filed: Mar. 8, 2007

Related U.S. Application Data
(60) Provisional application No. 60/780,387, filed on Mar. 9, 2006.

(51) Int. Cl. G06F 15/16

(52) U.S. Cl. 709/246

(57) ABSTRACT

A dynamically adaptable data connector is provided. The connector can dynamically adapt to connect disparate systems regardless of system initiation protocol, data type, data format, transfer protocol, content encoding, etc. Accordingly, data can be converted or otherwise configured to effectuate communication between disparate systems that were not originally designed for such communication. As well, the connector can cause the raw data (e.g., unmodified data) to be maintained for subsequent use if necessary or desired.

### CROSS-REFERENCE TO RELATED APPLICATIONS

This application claims the benefit of U.S. Provisional Patent application Ser. No. 60/780,387 entitled “METHOD AND SYSTEM FOR DATA CONNECTIONS BETWEEN DISPARATE SYSTEMS” and filed Mar. 9, 2006. The entirety of the above-noted application is incorporated by reference herein.

### BACKGROUND

A long-time effort among developers of data systems has been to connect disparate systems in order to transfer data from one to another. Unfortunately, this has proven difficult because many systems are not designed to send outbound or receive inbound data, because various systems use different encoding and messaging standards, and because the mechanisms of data transfer that the system can handle may differ between various systems.

By way of example, a hospital's laboratory system may send data via a TCP/IP (Transmission Control Protocol/Internet Protocol) socket connection, in messages in the HL-7 v2.5 (pipe-delimited) format, with the message data encoded using the LOINC (Logical Observation Identifiers, Names and Codes) terminology standard. A downstream system that requires a laboratory data feed may only be able to receive data via FTP (File Transfer Protocol) connections, in messages encoded in XML (extensible markup language), with the message data encoded using the SNOMED (Systemized Nomenclature of Human and Veterinary Medicine) terminology standard.

In accordance with conventional systems, connecting these two systems would not be feasible. The only way to accomplish this type of connection would be through a highly customized software package written specifically for this particular purpose, or by connecting several pieces of unrelated software in a manner that would create a complicated, fragile, and un-maintainable system architecture. Both of these traditional customized mechanisms were both time consuming and expensive to implement.

Generally, data transfer systems might utilize any of the following mechanisms to manage the initiation of the data transfers: manually-initiated transfer, scheduled data transfers, transfers initiated by a mechanism to poll for new or modified data, or real-time data streaming across a socket. Traditional systems most often employ a single one of the mechanisms, or rarely two of them. However, these traditional systems are limited by the mechanisms of initiating the data transfers that can be accommodated.

When situations arise where the systems that need to be connected require transfer initiation mechanisms that the conventional systems cannot accommodate, the systems cannot be connected. As well, conventional systems are limited in the data transfer medium that can be used. Examples of transfer media include, but are not limited to, a data bus in a particular computer, a serial port, a parallel port, a USB (Universal Serial Bus) port, a FireWire port and a network port.

These traditional systems cannot handle the diversity of data transfer media, and therefore, are extremely limited in the types of systems that they can connect. In other words, when systems that need to be connected require transfer media that the traditional systems cannot accommodate, the systems cannot be connected.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises an adaptable connector that can connect disparate systems regardless of data type, data format, transfer protocol, etc. Essentially, the connector can enable data to be converted or otherwise configured to effectuate communication between disparate systems. As well, the connector can cause the raw data (e.g., unmodified data) to be maintained for subsequent use if necessary.

In operation, the connector can enable most any two systems to communicate thereby sharing data, despite differences in the manner in which the data transfers are expected to be initiated, despite differences in the media for data transfer required, despite differences in the transfer protocol each system can manage, and despite differences in the expected messaging format and content encoding between the systems. Additionally, the connector facilitates systems and methodologies to send data to and/or receive data from external systems even when they were not originally designed to have such capability. In other words, the connector is adaptable to the specifics of two (or more) systems that desire to be connected. The connector can dynamically adapt to different formats and/or protocols on an as-needed basis.

In yet another aspect thereof, an machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a block diagram of a data connector system in accordance with an aspect of the innovation.

FIG. 2 illustrates an example flow chart of procedures that facilitate receiving data in accordance with an aspect of the innovation.

FIG. 3 illustrates an example flow chart of procedures that facilitate sending data in accordance with an aspect of the innovation.

FIG. 4 illustrates an example architecture block diagram of a connector in accordance with an aspect of the innovation.

FIG. 5 illustrates example data configuration layers in accordance with an aspect of the innovation.

FIG. 6 illustrates a block diagram of a computer operable to execute the disclosed architecture.

FIG. 7 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

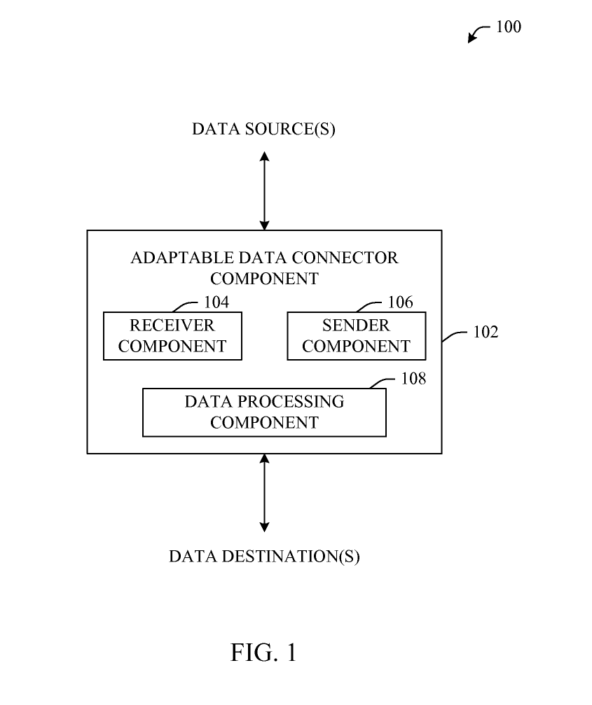

Referring initially to the drawings, FIG. 1 illustrates a system 100 that facilitates transfer of data from a data source or between two entities by way of an adaptable data connector component 102. Essentially, adaptable data connector component 102 facilitates data connections between disparate systems that employ different transmission protocols to send and/or receive data. As well, the adaptable data connector component can facilitate data transfer between systems that employ different transfer media mechanisms. By way of example, transfer media mechanisms can include, but are not limited to, a data bus in a particular computer, a serial port, a parallel port, a USB (Universal Serial Bus) port, a FireWire port or a network port.

Generally, adaptable data connector component 102 can include a receiver component 104, a sender component 106 and a data processing component 108. Each of these components will be described in greater detail infra. As illustrated, it will be understood that the adaptable data connector component 102 can facilitate one-to-one, one-to-many, many-to-one or many-to-many transmission between data sources and data destinations. Additionally, upon a review of the figures that follow, it will be understood that data processing component 108 can include an archive data store, processing scripts, data storage location(s), etc.

The subject adaptable data connector component 102 that facilitates data connection between disparate systems can also be referred to as an ‘any-to-any data connector’, or simply a ‘connector.’ In operation, the receiver component 104 can receive data in a continuous stream or as discrete blobs, in a scheduled or unscheduled manner. For example, data can be pushed or pulled from a source in real-time, almost real-time, based upon a predefined or inferred schedule or policy, or randomly.

Data can be received from almost any digital source, including but not limited to a socket-based connection using virtually any commonly used protocol such as FTP (File Transfer Protocol) and HTTP (Hypertext Transfer Protocol), custom TCP/IP (Transmission Control Protocol/Internet Protocol) socket-based protocols, polling of a system file directory on a local or remote computer, polling of a POP3 (Post Office Protocol version 3) email box, polling of a database, and listening on a serial port, a parallel port, a USB (Universal Serial Bus) port, or a Firewire port.

Upon receipt, the connector 102 can pass the data (e.g., via data processing component 108) to an external custom script for processing as needed. In other aspects, scripts can be employed within the data processing component 108. The received data can be then saved within the system files or in a database. An archived copy of the original data (e.g., raw, unprocessed data) can also saved in system files, in a database or other suitable mechanism.

The connector 102, via the sender component 106, can access the processed data from the system files or database in which they are stored and sends them out to the recipient system or destination(s). The outbound data can be sent using most any of the methods that a receiver component 104 can use to receive data. It is to be appreciated that more than one system can be configured to receive an outbound data feed. In other words, the connector 102 can be configured with multiple sender components 106 that facilitate transfer of data to multiple destinations.

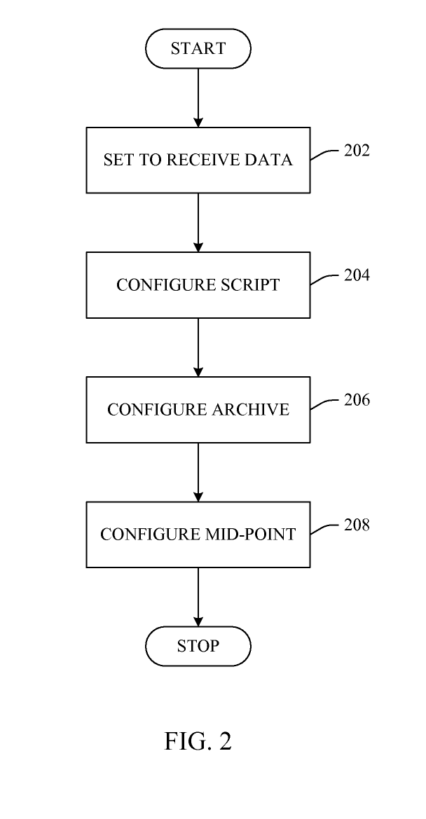

FIG. 2 illustrates a methodology of receiving data in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a data connection is initiated by setting the connector 102 to receive data. In other words, at 202, the data connection is created by instantiating software as a receiver and setting it to receive data from a particular source (or group of sources). As described above, in aspects, the receipt of data from a particular source (or group of sources) can be set to a particular schedule or policy. Accordingly, the schedule or policy can be predefined or inferred using machine learning and/or reasoning (MLR) mechanisms.

An external script can be configured at 204 to process the incoming data to meet the needs of the data connection. In other words, the external script can be employed to transform or otherwise configure the incoming data to meet the criteria of the receiving entity. An archive is configured at 206 to accept and store the raw data received from the source system.

At 208, a midpoint location is configured to accept and store the processed data from the receiver. It is to be understood that the term ‘store’ can refer to most any mechanism of maintaining the information including, but not limited to, hard disk storage, memory, buffer, cache, etc.

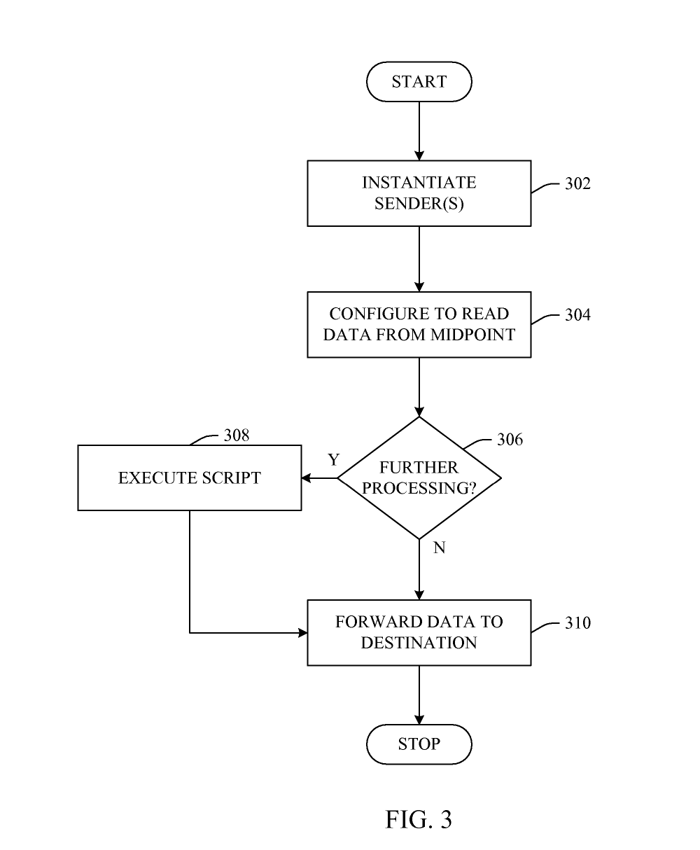

Referring now to FIG. 3, there is illustrated a methodology of sending data in accordance with the connector described within this disclosure. For each receiver, one or more instances of the software can be instantiated as senders at 302. Accordingly, at 304, each is configured to read new data from the midpoint location and ultimately to forward that data to the destination system.

A decision is made at 306 to determine if further processing is required. As needed, at 308, each instantiation of the sender can be configured to load and execute a custom script that can further process the message in order to meet the needs of a destination system. Whether further processing is needed or not, at 310, the data can be forwarded to the destination or group of destinations.

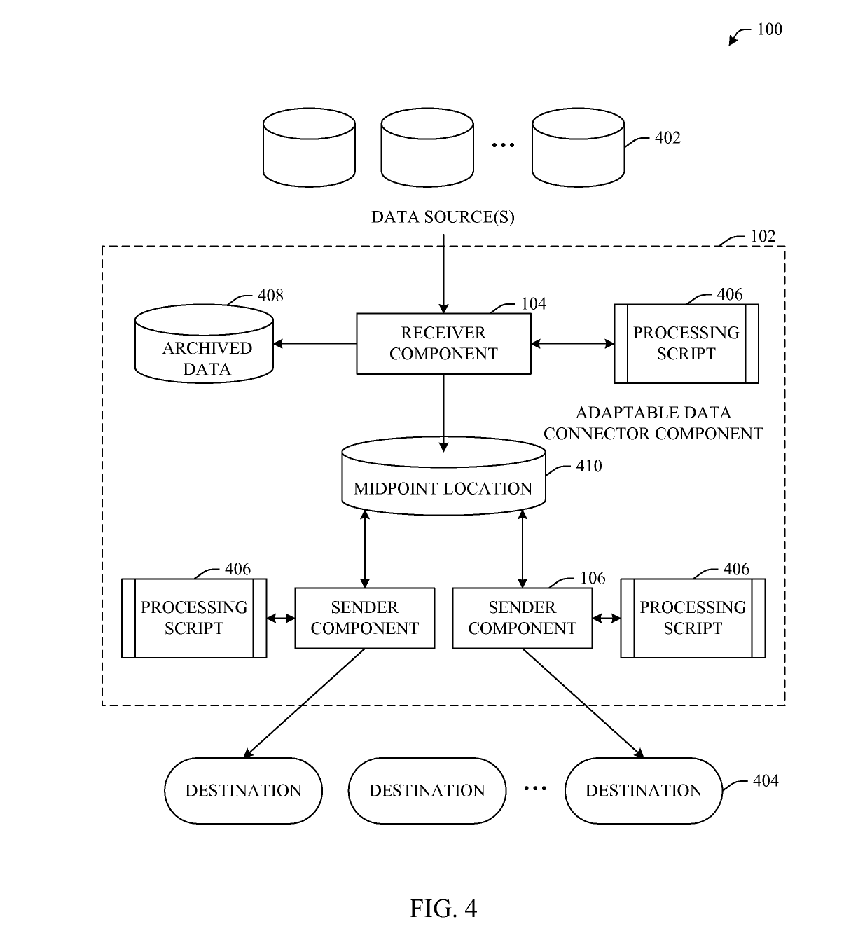

Turning now to FIG. 4, illustrated is an example architectural block diagram of data connector system 400 that facilitates data receipt and transfer in accordance with an aspect of the innovation. Generally system 400 can include a multi-format connector component 102 that facilitates transfer of data from 1 to M data sources 402 to 1 to N destinations where M and N are integers.

As described above, the subject system 400 relates generally to providing data connections between disparate digital systems (e.g., data sources 402 and destinations 404). More specifically, the system 400 can employ a receiver component 104 that receives, accesses, or otherwise obtains data from a source system, for example data sources 402. If necessary, the receiver component 104 can employ a processing script 406 to process the data as needed to conform to the receiver component 402. In an aspect, the script 406 (or group of scripts (not shown)) can be located externally and accessed by the receiver component 104 when needed.

Further, the receiver component 104 can archive the original (e.g., raw) data in an archived data storage mechanism 408 (e.g., hard disk, memory, buffer, cache). The processed data can be transferred to a midpoint location 410 which can be accessed by a sender 106 and ultimately forwarded to a destination system (or group of systems). As shown, if necessary, processing scripts 406 can be employed to configure the data into a format compatible with a destination system 404. Essentially, the multi-format connector component 102 connects systems that cannot natively send or receive data, those that send or receive data using compatible or incompatible methods, as well as compatible or incompatible data format standards.

It will be understood that conventional connector systems are limited in the data transfer protocols that can be used. In other words, conventional connector systems must be hard-coded or customized to employ a specific transfer protocol. Contrary to these conventional mechanisms, the subject connector 102 can dynamically adapt to most any transfer protocol and need not be preconfigured to a specific protocol. Examples of transfer protocols can include, but are not limited to include, proprietary database connection protocols; Windows-based protocols; and socket-based protocols such as FTP, UDP (User Datagram Protocol), and HTTP.

While the subject connector 102 can, the conventional connectors cannot handle the diversity of data transfer protocols, and therefore these conventional systems are extremely limited in the types of systems that they can connect. In other words, when the systems that need to be connected require data transfer protocols that the conventional systems cannot accommodate, the systems cannot be connected.

Further, conventional systems are limited in the messaging formats and data encoding that can be used. Contrary to these conventional systems, the subject connector 102 can employ most any messaging format or combinations thereof to connect disparate systems. Examples of messaging formats can include, but are not limited to, XML, SGML (Standardized Generalized Markup Language), HL-7 (Health Level 7) formatting and protocol standard in its various versions, delimited, fixed-length format, HTML, and custom messaging formats.

Additionally, the subject connector 102 can be employed with most any encoding formats known in the art. Examples of data encoding formats in the medical industry include, but are not limited to LOINC, SNOMED-CT, ICD-9, and CPT. Traditional systems cannot handle the diversity of data encoding formats, and therefore are limited in the types of systems that they can connect. When the systems that need to be connected require data encoding formats that the traditional systems cannot accommodate, the systems could not be connected using these conventional systems. However, the subject connector 102 is capable of dynamically adapting to most any encoding format in order to enable communication between disparate systems.

Still further, it is to be understood that the conventional systems are not only limited by the diversity of initiation mechanisms, transfer media, transfer protocols, messaging formats and encoding formats that can be accommodated, another drawback of these traditional systems is that they ‘tightly couple’ the receipt of data from a source system to the sending of the data to a destination system. It will be understood that tight coupling means that any problems or failures that occur in any element of any data connection will affect the entire architecture.

For example, in a tightly coupled traditional system, a failure in a single destination system will affect the entire connection. This failure will cause the source system to fail to send out new messages. As well, it may actually cause the source system to crash. Moreover, the failure of the source system to send out new messages affects all other destination systems that would otherwise receive the data.

As described above, the conventional systems are limited by the ability of the source and destination systems' native ability to send and receive new data. Many of these systems were not designed to feed out new data to outside sources, or to receive new data from outside sources. Yet, this is oftentimes exactly what is needed and/or desired.

Returning to FIG. 4, the current system 400 provides a mechanism that can archive an original (e.g., raw) copy of every piece of data that it receives in archived data component 408. This archive (408) can ensure that if there is a problem in the translation or the sending of a message, the message can be reprocessed and/or resent. This is a significant advantage over conventional systems, in which failed, corrupted, or improperly translated messages cannot be recovered and/or reprocessed and/or resent.

As described supra, the subject connector 102 provides data connections between disparate systems. More particularly, the connector 102 provides a process whereby almost any two systems can be connected to share data, despite differences in the way the data transfers are expected to be initiated, despite differences in the media for data transfer required, despite differences in the transfer protocol each system can manage, and despite differences in the expected messaging format and content encoding between the systems.

Furthermore, the connector 102 facilitates methodologies for many systems to send data to and/or receive data from external systems even when they were not originally designed to have this capability. The systems can dynamically adapt to different formats and/or protocols on an as-needed basis. In contrast to the ‘tightly coupled’ traditional systems, the subject connector 102 ‘loosely couples’ its connections in order to maximize the stability and reliability of all connections and connected systems. Not only can the connector 102 connect systems despite their data transfer capabilities, it can even connect systems with incompatible data transfer capabilities, message formats, and data formats.

The general architecture of the system 400 includes mechanisms or components that can be instantiated in one of two modes - sender mode or receiver mode. Multiple instances of the connector subcomponents (e.g., receiver 104, sender 106) can reside on a system. In receiver mode, the software can poll (or otherwise obtain) virtually any database object or system file directory for new elements. It can also listen on a network socket or across a computer's port for real-time messages and data transfers.

In sender mode (e.g., 106) the connector can send data across a network socket, a computer's port, to database objects, or to system directories as system files. The receiver 104 can save the original or raw data that it receives, for example, in an archive 408 of either system files or a database table. The data can be passed to an external script 406 so that it can be processed into most any other format required by the system. The output of that script can then saved to another system file directory or database table (e.g., midpoint location 410).

The sender 106 can poll the system file directory or the database containing the processed data (e.g., midpoint location 410) to identify new items dropped by the receiver 104. The sender 106 can forward those new items to the destination system 404. It is to be understood that this architecture 400 ensures that the source and destination systems are connected, but loosely coupled.

In aspects, the connector 102 can utilize any of the following mechanisms to manage the initiation of the data transfers: manually-initiated transfer, scheduled data transfers, transfers initiated by a mechanism to poll for new or modified data, or real-time data streaming across a socket. Additionally, the initiation can be user defined and/or inferred by way of MLR mechanisms. It will be understood that this is a significant improvement over conventional systems that generally utilize just one, or occasionally two, of the mechanisms. Additional functionality of the subject connector 102 enables connection of two systems that utilize different data transfer initiation mechanisms. For example, the connector 102 can connect a system that sends out scheduled data transfers with one that expects to receive data streamed across a socket.

Yet another aspect of the innovation (e.g., connector 102) is that it can utilize a diverse array of transfer media that include, but are not limited to, the data bus in a particular computer, the serial port, the parallel port, the USB port, the FireWire port and the network port. This is a significant improvement over traditional systems, as they cannot handle the diversity of data transfer media, and therefore are limited in the types of systems that they can connect. Moreover, the connector 102 can even connect source/destination systems that do not utilize the same transfer media.

For instance, by employing processing scripts, the innovation can connect a system that sends data to a serial port with a system that receives data via an Ethernet port. The innovation can utilize a wide variety of transfer protocols that include, but are not limited to, proprietary database connection protocols; Windows-based protocols; and socket-based protocols such as FTP and HTTP. As stated above, traditional systems cannot handle the diversity of data transfer protocols, and therefore are limited in the types of systems that they can connect.

Still further, the connector 102 disclosed herein can connect systems that do not utilize the same protocols. For example, the innovation can connect a system that can send data via FTP to one that can receive data via HTTP. In operation, the connector 102 can handle and translate between virtually any messaging format, including, but not limited to, XML, SGML, HL-7 in its various versions, delimited, fixed-length format, HTML, and custom messaging formats. It can also handle and translate data between virtually any data encoding method. Examples of data encoding formats from the medical industry that the subject innovation can manage include, but are not limited to, LOINC, SNOMED-CT, ICD-9, and CPT. Conventional systems cannot handle the diversity of message and data encoding formats, and therefore are limited in the types of systems that they can connect.

In other aspects, the subject innovation can connect systems that do not use the same message format and data terminologies. For example, a system that sends data encoded as ICDI 9 in an XML message can be connected with one that receives data encoded with SNOMED-CT in a pipe-delimited HL-7 format. This adaptability is a significant improvement over earlier systems in its use of ‘loose coupling.’ Whereas, as described supra, ‘tight coupling’ of systems ensures that a failure anywhere in the data connection will propagate across all connections and all systems. Here, the ‘loose coupling’ attenuates the effects of a failure in the connection path.

The subject innovation interposes a step in which messages/data are stored in system files or a database after receipt before they are forwarded to the destination systems. This loose coupling ensures that even if a single destination system or connection has a problem, the sending system and the other destination systems can continue to send or receive without being affected. This is a significant improvement over tightly coupled systems.

In other aspects, the subject innovation is a significant improvement over the traditional systems by virtue of its ability to create an outbound data feed for many systems that do not natively have that capability. It also improves by virtue of its ability to create a method to handle an inbound data feed for many systems that do not natively have that capability.

With continued reference to FIG. 4, a high-level schematic of the system 400 is shown. As described supra, the system 400 includes an adaptable data connector component 102 that can send data, receive data, and save data to either a system file directory or a database. In aspects, the connector 102 can be instantiated as a service on a computing device. In operation, more than one instance of the connector 102 can be installed and/or active at any one time. Each instance of the connector 102 can be configured to serve as either the sender (106) or the receiver (104), such that the single computing device can have multiple instances running as a service, some of which are serving as receivers (104), and the others serving as senders (106).

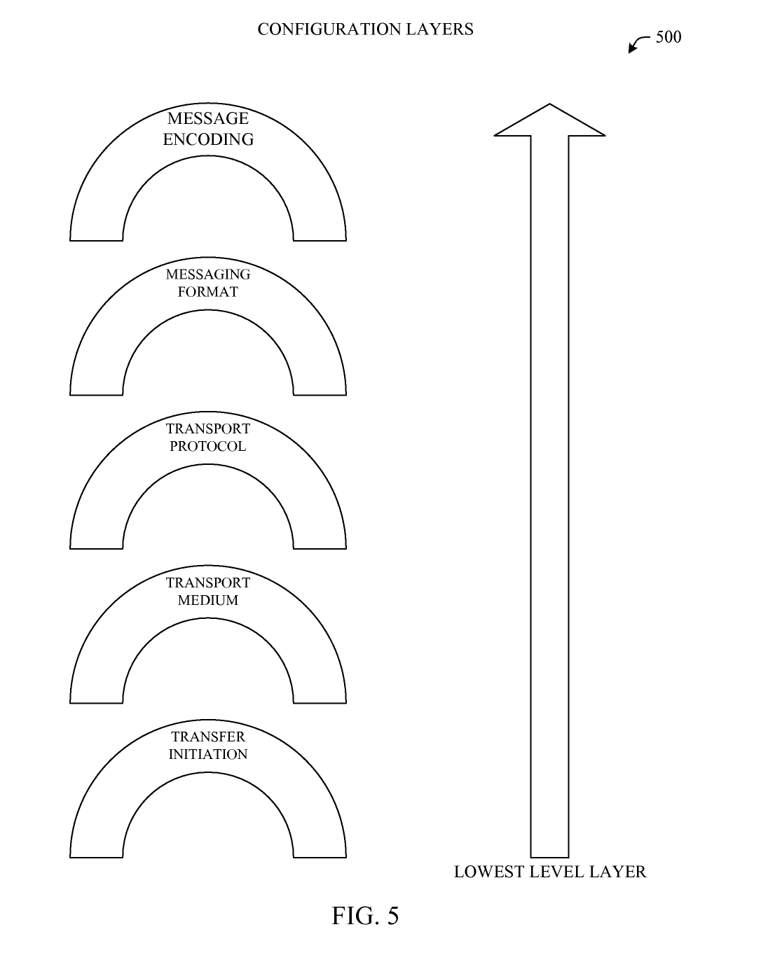

FIG. 5 illustrates an example set of configuration layers in accordance with an embodiment of the innovation. Each instantiation of the connector 102 can be configured to meet the particular needs of that instance, for example, as illustrated in FIG. 5. As a receiver (104), the configuration can include, but is not necessarily limited to include, a mechanism and parameters by which the connector 102 receives data, a mechanism and parameters employed for saving the original data to an archive location 408, a mechanism and parameters employed to run a processing script 406, e.g., an external script to process the message, and a mechanism and parameters employed for saving the processed data at a midpoint location 410.

The midpoint location 410 can be configured to be a directory in a file system on either the local computer or a remote computer. In other aspects, the midpoint location 410 can be configured to be a database on the local computer or a remote computer. In either case, the midpoint 410 can also be configured as a distributed directory or database storage mechanism that is located resident, remote or any combination thereof.

As a sender 106, the configuration can includes, but is not necessarily limited to include, a mechanism and parameters by which the connector 102 accesses (or otherwise obtains) data from the midpoint location 410, a mechanism and parameters the sender 106 employs to monitor and/or poll for new data at the midpoint location 410, and a mechanism and parameters employable to send data to its final destination. The sender 106 can also, if needed, be configured to pass the data it pulls from the midpoint location 410 for additional processing before sending the data to its final destination 404. More particularly, the sender 106 can employ processing scripts 406 to process data in accordance with a particular destination 404.

In operation, each instance of the receiver 104 can be configured to receive data through any one of a diversity of methods that include, but are not limited to, polling of a local system file directory for new files, polling of a remote system file directory for new files, polling of a local database table or view for new or modified data, polling of a remote database table or view for new or modified data, polling of a local system file for changes in content, polling of a remote system file for changes in content, listening on a computer port such as a USB port, a serial port, a parallel port, and a FireWire port, and listening on a network socket. The socket can be a UDP or TCP/IP socket, and the protocol across the socket can include most any of many common protocols including FTP, HTTP, and POP3, as well as custom protocols.

Each message received by the receiver 104 can be processed by a script 104. The script 104 is most likely not compiled into the software of the connector 102, but rather lives outside of the software as an external file. The connector 102 (or, more particularly, the receiver 104) can access the script 406 and execute it, passing the data it received as a script parameter. The script 406 can return the processed data to the receiver 104.

The script 406 can take any arbitrary action as needed to accomplish the data transfer. In particular, the script 406 can repackage a message from one format to another, for example, from pipe-delimited HL-7 to XML. Additionally, it can convert the contents of a message from one encoding method to another, for example, from English units to Metric units. Furthermore, it can take virtually any other action necessary related to compatibility of data.

Each instance of the sender 106 can be configured to send data through any one of a diversity of mechanisms that include, but are not limited to, writing a system file to a local system file directory, writing a system file to a remote system file directory, writing to a local database table or view, writing to a remote database table or view, modifying a local system file, modifying a remote system file, writing to a computer port such as a USB port, a serial port, a parallel port, or a FireWire port, and sending data on a network socket. In this example, the socket can be a UDP or TCP/IP socket, and the protocol across the socket can include most any protocols including FTP, HTTP, and POP3, as well as custom protocols.

As described in detail supra, the data connection is created by instantiating the connector 102 as a receiver 104 and setting it to receive data from a particular source (e.g., data source(s) 402). As described above, an external script 406 can be configured to process the incoming data to meet the needs and/or criteria of the data connection. An archive 408 can be configured to accept and store the raw data received from the source system. A midpoint location 410 can be configured to accept and store the processed data from the receiver 104. For each receiver 104, one or more instances of the connector 102 are instantiated as senders 106. Each can be configured to read new data from the midpoint location 410 and forward that data to the destination system (e.g., destination(s) 404). As needed, each instantiation of the sender 106 can be configured to load and execute a custom script 406 that can further process the message in order to meet the needs of a destination system, for example destination(s) 404.

Due to the nature of the different possible configurations, the subject innovation may require the sender instantiation 106 and the receiver instantiation 104 to be created on the same machine or device. As well, it is possible for these instantiations to reside on different machines or devices. The innovation allows for any of these architectures which are intended to be included within the scope of this disclosure and claims appended hereto. Additionally, any or all instantiations of the connector 102 can live on the same computer or device as the source system, the same computer as the receiving system, or on other computers that host neither the source nor the destination systems. The configuration of an instantiation often dictates where the connector 102 will be instantiated. For example, an instantiation of the connector 102 that listens across a specific computer's port must be instantiated on a system that can physically access that port. Other configurations and instantiation examples will be appreciated by those skilled in the art. As such, these alternative aspects are to be included within the scope of the subject disclosure and claims appended hereto.

Aspects of the aforementioned and described connector can employ an MLR component which facilitates automating one or more features in accordance with the subject innovation. The subject innovation (e.g., in connection with selection of formats or transfer protocols) can employ various MLR-based schemes for carrying out various aspects thereof. For example, a process for determining which format to configure and which script to access to most efficiently perform the configuration can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria which formats to select, which transfer protocols to employ, etc.

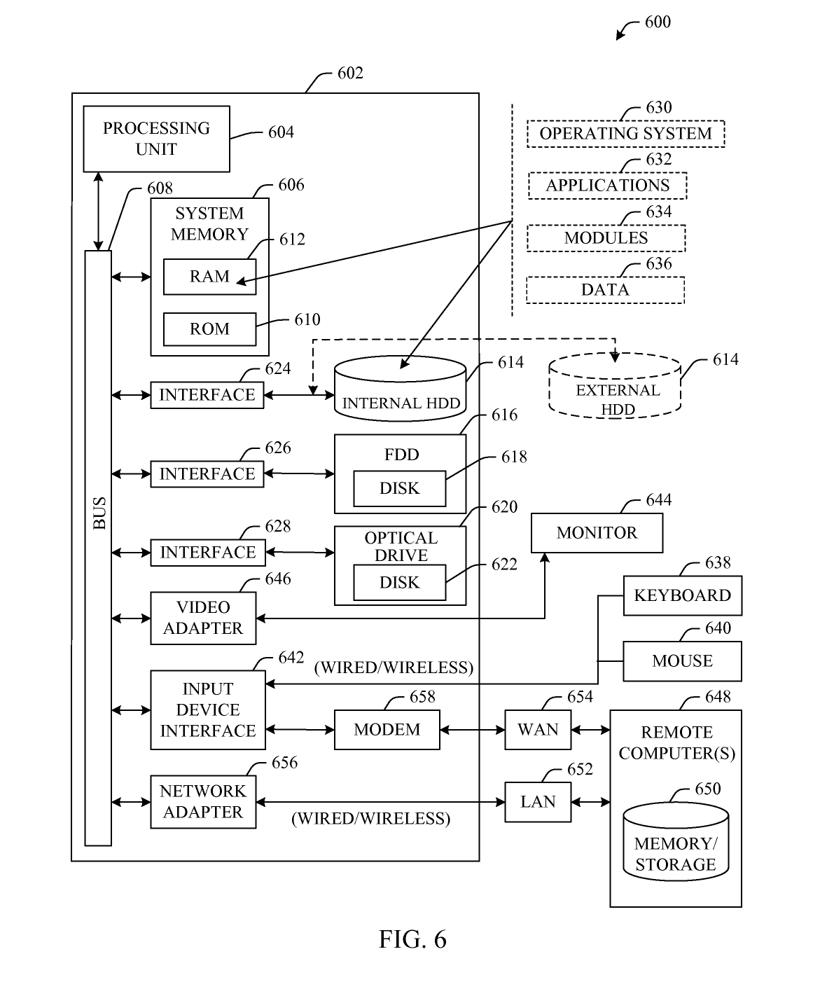

Referring now to FIG. 6, there is illustrated a block diagram of a computer operable to execute the disclosed architecture. In order to provide additional context for various aspects of the subject innovation, FIG. 6 and the following discussion are intended to provide a brief, general description of a suitable computing environment 600 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 6, the exemplary environment 600 for implementing various aspects of the innovation includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data.

The computer 602 further includes an internal hard disk drive (HDD) 614 (e.g., EIDE, SATA), which internal hard disk drive 614 may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 612, including an operating system 630, one or more application programs 632, other program modules 634 and program data 636. All or portions of the operating system, applications, modules, and/or data can also be cached in the RAM 612. It is appreciated that the innovation can be implemented with various commercially available operating systems or combinations of operating systems.

A user can enter commands and information into the computer 602 through one or more wired/wireless input devices, e.g., a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc.

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, e.g., a wide area network (WAN) 654. Such LAN and WAN networking environments are commonplace in offices and companies, and facilitate enterprise-wide computer networks, such as intranets, all of which may connect to a global communications network, e.g., the Internet.

When used in a LAN networking environment, the computer 602 is connected to the local network 652 through a wired and/or wireless communication network interface or adapter 656. The adapter 656 may facilitate wired or wireless communication to the LAN 652, which may also include a wireless access point disposed thereon for communicating with the wireless adapter 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

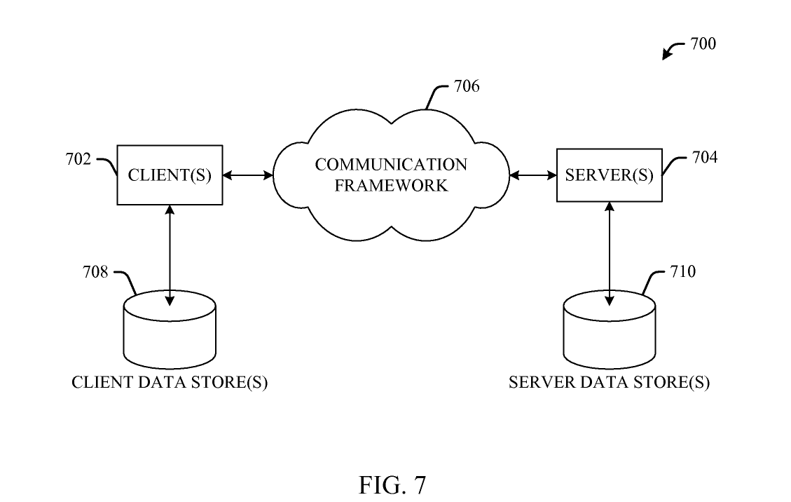

Referring now to FIG. 7, there is illustrated a schematic block diagram of an exemplary computing environment 700 in accordance with the subject innovation. The system 700 includes one or more client(s) 702. The client(s) 702 can be hardware and/or software (e.g., threads, processes, computing devices). The client(s) 702 can house cookie(s) and/or associated contextual information by employing the innovation, for example.

The system 700 also includes one or more server(s) 704. The server(s) 704 can also be hardware and/or software (e.g., threads, processes, computing devices). The servers 704 can house threads to perform transformations by employing the innovation, for example. One possible communication between a client 702 and a server 704 can be in the form of a data packet adapted to be transmitted between two or more computer processes. The data packet may include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A loosely coupled system that facilitates data connection, comprising:
a receiver component that obtains data from a plurality of data sources, wherein the data is received in a plurality of formats; and
a sender component that automatically configures a subset of the data into a format consistent with a destination and transfers the subset of the data to the destination.

2. The system of claim 1, wherein the receiver component employs a processing script to automatically configures the information into a format consistent with the receiver component.

3. The system of claim 1, wherein the processing script is an external processing script.

4. The system of claim 1, further comprising the processing script.

5. The system of claim 1, further comprising an archive data storage component that facilitates storage of the data as received by the receiving component.

6. The system of claim 5, further comprising a midpoint location that facilitates storage of the data processed by the receiver component, wherein the sender component accesses the subset of the data from the processed data maintained in the midpoint location.

7. The system of claim 1, further comprising a processing script that enables the sender component to configure the data in the format consistent with the destination.

8. The system of claim 1, wherein at least a subset of the data sources employs a transfer protocol different from the destination.

9. The system of claim 1, further comprising a machine learning and reasoning component that employs at least one of a probabilistic and a statistical-based analysis that infers an action that a user desires to be automatically performed.

10. A computer-implemented method of connecting data between systems having that employ disparate data formats, comprising:
receiving data from a data source in a first format;
processing the data into a second format consistent with a destination;
storing the processed data in a midpoint location;
accessing the data from the midpoint location; and
sending the accessed data to the destination.

11. The method of claim 10, further comprising storing the data in the first format.

12. The method of claim 10, further comprising processing the data in the second format to conform to a destination transfer protocol which is different from a source transfer protocol of the plurality of sources.

13. The method of claim 12, the destination transfer protocol is one of a proprietary database connection protocol, a Windows-based protocol, or a socket-based protocol and the source transfer protocol is one of the other of the proprietary database connection protocol, the Windows-based protocol or the socket-based protocol.

14. The method of claim 1, the first format is one of XML (Extensible Markup Language), SGML (Standardized Generalized Markup Language), HL-7 (Health Level 7), or a custom messaging format.

15. A computer-executable system that facilitates data connection, comprising:
means for receiving raw data from a source in a format different from that of a format of a target destination;
means for processing the received data into the format of the receiving system;
means for storing the processed data in the format of the receiving system; and
means for transmitting the processed data to the destination.

16. The computer-executable system of claim 15, further comprising means for archiving the raw data.

17. The computer-executable system of claim 15, further comprising means for monitoring the means for storing the processed data and means for accessing the processed data in one of real-time or a scheduled manner.

18. The computer-executable system of claim 15, further comprising means for accessing the processed data and means for further processing the processed data to conform to the target destination.

19. The computer-executable system of claim 15, the source and the destination employ disparate transfer protocols.

20. The computer-executable system of claim 19, the source employs one of a proprietary database connection protocol, a Windows-based protocol, or a socket-based protocol and the source employs one of the other of the proprietary database connection protocol, the Windows-based protocol or the socket-based protocol.
